(19) United States
(12) Patent Application Publication
(10) Pub. No.: US 2011/0001860 A1
(43) Pub. Date: Jan. 6, 2011

(54) SOLID-STATE IMAGING DEVICE

(76) Inventors: Hisayuki TARUKI, Odawara-shi (JP); Nagataka Tanaka, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/827,190

(22) Filed: Jun. 30, 2010

(30) Foreign Application Priority Data
Jul. 1, 2009 (JP) 2009-157117

(51) Int. Cl. H04N 5/335

(52) U.S. Cl. 348/300; 348/E05.091

(57) ABSTRACT

According to one embodiment, a solid-state imaging device includes a solid-state imaging device includes a pixel array, load transistor, first switch transistor, and second switch transistor. The pixel array includes a plurality of unit pixels arranged in a matrix. Each unit pixel includes a photodiode, a read transistor, a reset transistor to which one of a first voltage and a second voltage, and an amplification transistor. The second switch transistor outputs a bias voltage to the vertical signal line.

### CROSS REFERENCE TO RELATED APPLICATIONS

This application is based upon and claims the benefit of priority from Japanese Patent Application No. 2009-157117, filed Jul. 1, 2009; the entire contents of which are incorporated herein by reference.

### FIELD

Embodiments described herein relate generally to an arrangement of a unit pixel of a solid-state imaging device.

### BACKGROUND

In a CMOS image sensor, a pixel pitch is increasingly reduced for various reasons. When a pixel pitch is reduced, a ratio of an area of transistors and signal lines occupied in a unit pixel becomes larger, thus decreasing an aperture ratio and lowering light sensitivity. A pixel array, which solves this problem, is disclosed in, for example, FIG. 1 of Japanese Patent No. 3579194. In this pixel array, an address transistor which makes row selection is omitted. An operation of a unit pixel is as follows. A pixel power supply voltage is reduced to Low level, and reset transistors of a plurality of unit pixels of respective unselected rows are enabled. Then, voltages of floating diffusions are set at Low level of the pixel power supply voltage, amplification transistors are disabled, and a plurality of pixels of respective unselected rows are set in an unselected state. After that, the pixel power supply voltage is raised to High level (VDD), and only reset transistors of a plurality of pixels of a selected row are enabled, and the voltages of the floating diffusions are set at VDD.

After the floating diffusions of the plurality of unit pixels of the selected row are reset to VDD, read transistors of the plurality of unit pixels of the selected row are enabled, and signal charges photoelectrically converted by respective photodiodes are transferred to the floating diffusions. Before the read transistors are enabled, current source transistors for source follower circuits are enabled, and signal voltages corresponding to the signal charges are amplified by the amplification transistors and are output onto vertical signal lines.

In the unit pixel described in the above reference, an address transistor is arranged on the source or drain side of each amplification transistor to set a gate electrode of the amplification transistor of each unselected row at a low voltage to attain row selection in place of selection of an output row. In order to set respective pixels of the respective unselected rows in an unselected state, signal charges have to be read out from a plurality of pixels of the selected row by temporarily reducing the pixel power supply voltage to Low level and then returning it to High level. However, at the time of returning the pixel power supply voltage to High level, the voltages of the floating diffusions are raised to be higher than Low level, which is set in advance, due to capacitive coupling with nodes of the pixel power supply voltage. When Low level of the pixel power supply voltage is set to be excessively low, leakages occur between the photodiodes and floating diffusions during accumulation. For this reason, Low level cannot be lowered by a voltage rise amount in the floating diffusions. Therefore, when signal charge amounts of pixels are large, leakages from the amplification transistors of the respective unselected rows to vertical signal lines increase, the dynamic range of the source-follower circuits is narrowed down, and saturated signal amounts of pixels cannot be sufficiently output.

Jpn. Pat. Appln. KOKAI Publication No. 2007-123604 discloses a solid-state imaging device which uses a pixel array in which address transistors are omitted. In this solid-state imaging device, a bias application transistor is connected to each vertical signal line, and is enabled to apply a bias voltage to the vertical signal line. In this solid-state imaging device, a pixel power supply voltage is fixed at High level without being pulse-driven, so as to set the vertical signal line in a floating state at a high potential, and a source-follower circuit is then activated to lower a voltage of the vertical signal line. At this time, reset transistors in unit pixels of a selected row are set ON, and those in unit pixels of the respective unselected rows are set OFF. Then, potentials of only floating diffusions in the unit pixels of respective unselected rows are reduced due to an inter line capacitive coupling with the vertical signal lines, and amplification transistors in the unit pixels of the respective unselected rows are disabled. In this manner, since the amplification transistors of the unit pixels of the respective unselected rows are disabled while always keeping the pixel power supply voltage at a high potential, blooming can be suppressed. However, since the voltages of the floating diffusions in the unit pixels of the respective unselected rows are controlled by only capacitive coupling between the floating diffusions and vertical signal lines, an output dynamic range is narrowed down.

### BRIEF DESCRIPTION OF THE DRAWINGS

FIG. 1 is a circuit diagram of a CMOS image sensor according to an embodiment;

FIG. 2 is a plan view showing the element structure of a unit pixel in the CMOS image sensor shown in FIG. 1;

FIG. 3 is a timing chart showing an example of the operation of the CMOS image sensor shown in FIG. 1; and

FIG. 4 is a graph showing the pixel signal read characteristics of the CMOS image sensor shown in FIG. 1.

### DETAILED DESCRIPTION

In general, according to one embodiment, a solid-state imaging device includes a pixel array, load transistors, first switch transistors, and second switch transistors. The pixel array includes a plurality of unit pixels arranged in a matrix. Each unit pixel includes a photodiode which photoelectrically converts incoming light and accumulates a signal charge, a read transistor which reads out the signal charge accumulated by the photodiode to a floating diffusion, a reset transistor which is connected between a intra-pixel power supply line to which one of a first voltage and a second voltage higher than the first voltage is supplied, and the floating diffusion, and sets the floating diffusion at one of the first voltage and the second voltage, and an amplification transistor which is connected between the intra-pixel power supply line and a vertical signal line, and amplifies a voltage of the floating diffusion. Each of the load transistor and first switch transistor are connected in series between the vertical signal line and a reference potential supply node. Each of the second switch transistor outputs a bias voltage to the vertical signal line. During a period in which the first voltage is supplied to the intra-pixel power supply line, the floating diffusions of unit pixels of respective unselected rows of the plurality of unit pixels are set at the first voltage via the reset transistors. Also, during a period in which the second voltage is supplied to the intra-pixel power supply line, the floating diffusions of unit pixels of a selected row of the plurality of unit pixels are set at the second voltage via the reset transistors, thus attaining row selection of the pixel array.

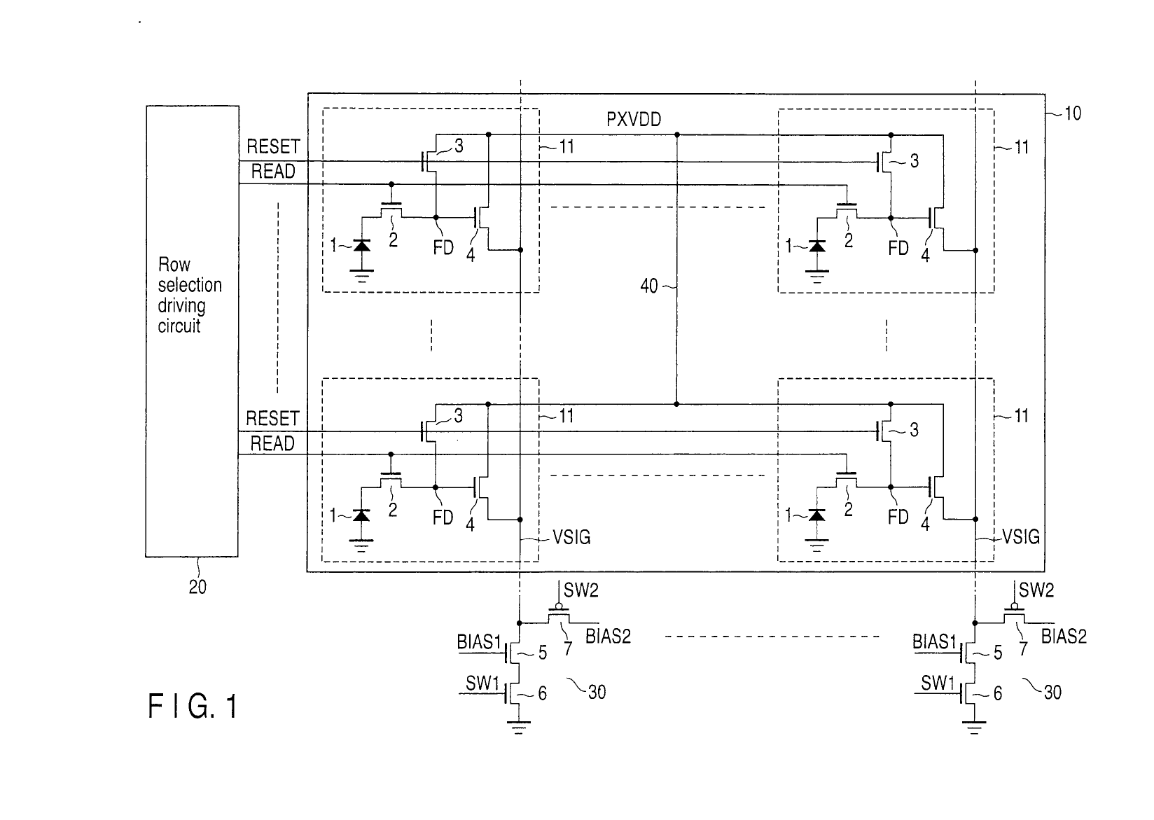

An embodiment will be described below with reference to the drawings. In this description, common reference numerals denote common parts throughout the drawings. FIG. 1 shows the arrangement of a CMOS image sensor according to an embodiment. This CMOS image sensor includes a pixel array 10 which includes a plurality of unit pixels 11 arranged in a matrix, a row selection driving circuit 20, a plurality of vertical signal lines (output signal lines) VSIG to which the unit pixels 11 in the pixel array 10 are connected for respective columns, and a plurality of pixel signal read-out circuits 30 which are respectively connected to the plurality of vertical signal lines VSIG.

Each unit pixel 11 has a photodiode 1 which photoelectrically converts incoming light, a read transistor 2 which transfers a signal charge photoelectrically converted by the photodiode 1 to a floating diffusion FD, a reset transistor 3 which resets a voltage of the floating diffusion FD to a voltage PXVDD supplied to an intra-pixel power supply line 40, and an amplification transistor 4 which amplifies a voltage of the floating diffusion FD, and outputs it onto the corresponding vertical signal line VSIG. Note that the voltage PXVDD supplied to the intra-pixel power supply line 40 changes between two values, for example, a ground voltage (first voltage) and VDD (second voltage) higher than the ground voltage.

Each pixel signal read-out circuit 30 includes a load transistor 5 and switch transistor 6, which are connected in series between the vertical signal line VSIG and a ground voltage node, and serve as a current source for a source-follower circuit. A bias voltage BIAS1 is input to the gate electrode of the load transistor 5, and a switch control signal SW1 is input to the gate electrode of the switch transistor 6. Normally, both of these transistors are N-channel MOSFETs.

Furthermore, each pixel signal read-out circuit 30 includes a switch transistor (for example, a P-channel MOSFET) 7 used to output a bias voltage BIAS2 to each vertical signal line VSIG. In each switch transistor 7, one end of a source-drain current channel is connected to the vertical signal line VSIG, the other end is connected to a voltage source of the bias voltage BIAS2, and a switch control signal SW2 is input to a gate electrode. The bias voltage BIAS2 is set to be a value higher than an operation range of the vertical signal line VSIG (an output level of a selected row). The bias voltage BIAS2 is set to be a value higher than, e.g., VDD.

The row selection driving circuit 20 selectively drives the unit pixels 11 in the pixel array 10 for respective rows, and outputs a reset pulse signal RESET to be supplied to the gate electrodes of the reset transistors 3 in the respective unit pixels 11, and a read pulse signal READ to be supplied to the gate electrodes of the read transistor 2.

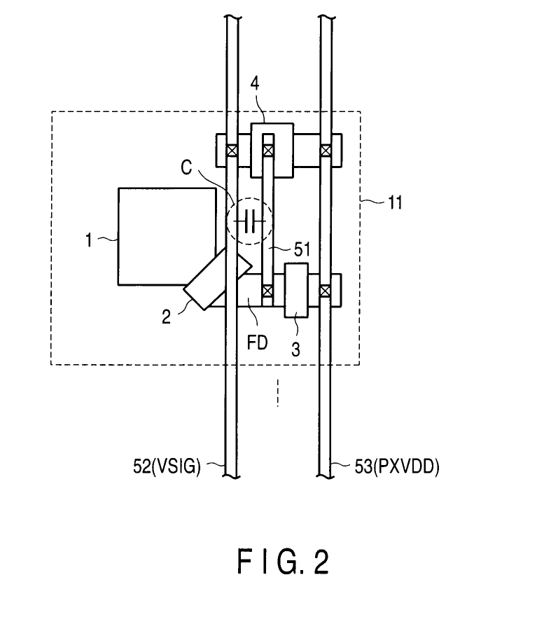

FIG. 2 is a plan view of the element structure of the pixel unit 11 in FIG. 1. The floating diffusion FD is a common region to the read transistor 2 and the reset transistor 3. The floating diffusion FD and the gate electrode of the amplification transistor 4 are connected to each other by a signal line 51 using, e.g., a metal conductive layer. The vertical signal line VSIG is made up of a signal line 52 using, e.g., a metal conductive layer. The signal line 51 is arranged parallel to the signal line 52. The intra-pixel power supply line 40 is made up of a signal line 53 using, e.g., a metal conductive layer, and the signal line 51 is arranged further parallel to the signal line 53. A capacitance C is parasitically generated between the signal lines 51 and 52, and a value of the parasitic capacitance C is relatively large. For this reason, large capacitive coupling is readily generated between the signal lines 51 and 52.

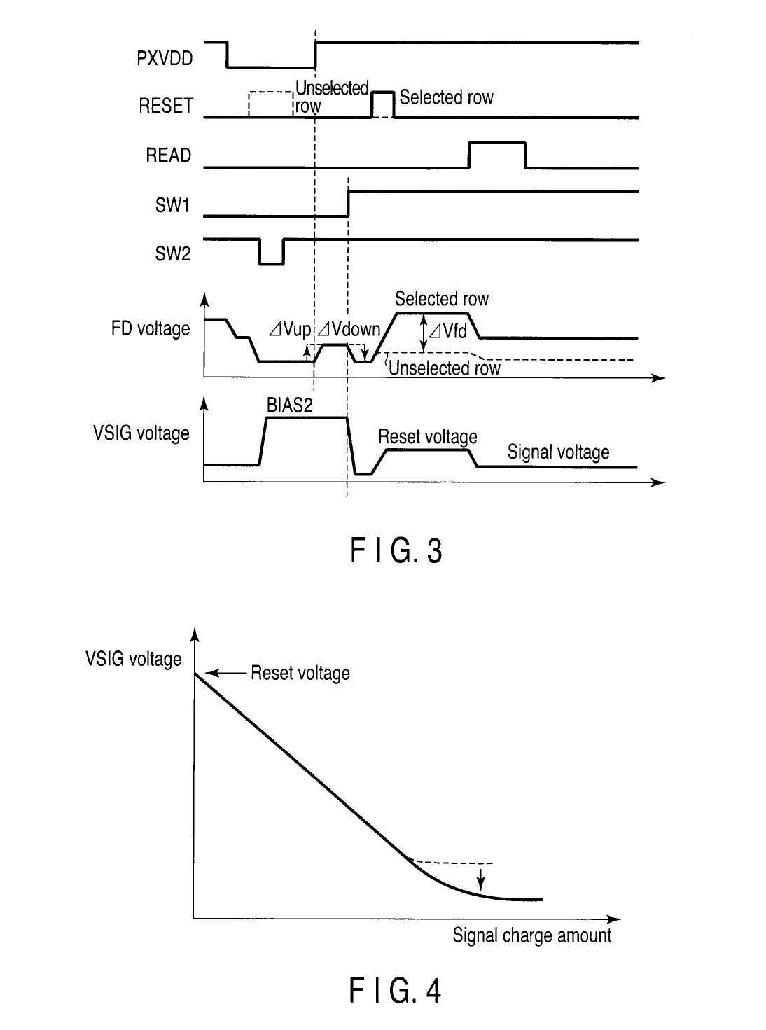

A pixel signal read-out operation in the CMOS image sensor shown in FIG. 1 will be described below using FIGS. 3 and 4. FIG. 3 is a timing chart, and FIG. 4 is a graph showing the pixel signal read characteristics in the CMOS image sensor shown in FIG. 1. During a first period, the voltage PXVDD of the intra-pixel power supply line 40 is reduced to Low level (e.g., the ground voltage), and the row selection driving circuit 20 outputs the reset pulse signal RESET to respective unselected rows in the pixel array 10. Thus, the reset transistors 3 in the respective unit pixels 11 of the respective unselected rows are enabled, and the voltages of the floating diffusions FD are set at Low level supplied to the intra-pixel power supply line 40. As a result, the amplification transistors 4 in the respective unit pixels 11 of the respective unselected rows are disabled, thus setting a pixel unselected state.

During a period in which the voltages of the floating diffusions FD in the respective unit pixels 11 of the respective unselected rows are set at Low level supplied to the intra-pixel power supply line 40, the switch control signal SW2 goes to Low level to enable the switch transistors 7, and the bias voltage BIAS2 is output onto the respective vertical signal lines VSIG. As a result, the voltage of each vertical signal line VSIG is raised from a floating state, and is fixed to the bias voltage BIAS2. After that, the switch control signal SW2 is returned to High level to disable the switch transistors 7, thereby setting the vertical signal lines VSIG in the floating state while being maintained at the voltage BIAS2.

During a second period after the end of the first period, the voltage PXVDD of each intra-pixel power supply line 40 is raised to High level (VDD). Subsequently, the row selection driving circuit 20 outputs the reset pulse signal RESET to a selected row in the pixel array 10. Thus, the reset transistors 3 in the respective unit pixels 11 of the selected row are enabled, and the voltages of the floating diffusions FD are set at VDD. When the voltage PXVDD of the intra-pixel power supply line 40 is returned to High level, the voltages of the floating diffusions FD in the respective unit pixels 11 of the respective unselected rows rise by ΔVup due to capacitive coupling with the intra-pixel power supply line 40. Each vertical signal line VSIG is set in advance at the bias voltage BIAS2 higher than its operation range (the output level of the selected row) via the switch transistor 7. After that, when the switch transistors 6 are enabled and the load transistors 5 serving as current sources for source-follower circuits are activated, the voltages of the vertical signal lines VSIG are reduced. At this time, the voltages of the floating diffusions FD are decreased by ΔVdown due to capacitive coupling with the vertical signal lines VSIG. FIG. 3 exemplifies a case wherein the amplitudes of ΔVup and ΔVdown are equal to each other. However, the two amplitudes need not always be equal to each other.

ΔVdown is decided by a parasitic capacitance (corresponding to the capacitance C in FIG. 2) Cvsig between the floating diffusion FD and vertical signal line VSIG, a capacitance Cfd of the floating diffusion FD itself, and a voltage change amount ΔVsig of the vertical signal line VSIG, as given by:

ΔVdown=(Cvsig/Cfd)*ΔVsig (1)

Since a convergence value of a voltage of the vertical signal line VSIG when the load transistor 5 is active is constant, a voltage rise of the floating diffusion FD in each unit pixel 11 of each unselected row can be controlled by changing the value of the bias voltage BIAS2.

After the floating diffusions FD in the respective unit pixels 11 of the selected row are reset to the voltage VDD, the row selection driving circuit 20 outputs the read pulse signal READ to the selected row in the pixel array 10. When the read transistors 2 in the respective unit pixels 11 of the selected row are enabled in response to the read pulse signal READ, signal charges photoelectrically converted by the photodiodes 1 are transferred to the floating diffusions FD. Note that when the switch transistors 6 connected in series with the load transistors 5 are enabled in advance, signals read out to the floating diffusions FD are output onto the vertical signal lines VSIG via the amplification transistors 4.

According to this embodiment, since the switch transistors 7 are arranged, and the vertical signal lines VSIG are set at the high bias voltage BIAS2 via these switch transistors 7, the switch transistors 6 are enabled in response to the switch control signal SW1 to lower the voltages of the vertical signal lines VSIG, thereby reducing the voltages of the floating diffusions FD in the respective unit pixels 11 of the respective unselected rows by ΔVdown. In the selected row, the voltages of the floating diffusions FD after the reset transistors 3 in the respective unit pixels 11 are enabled are set at High level supplied to the intra-pixel power supply line 40. Therefore, a potential difference ΔVfd between the floating diffusions FD in the unit pixels 11 of the selected line and each unselected line increases. For this reason, even when a signal charge amount to be read out is large, the large potential difference ΔVfd with the voltage of the floating diffusion FD of each unselected row can be set, as shown in FIG. 3.

FIG. 4 shows the relationship between a signal charge amount to be read out from a selected unit pixel and VSIG voltage. A solid curve in FIG. 4 represents characteristics according to this embodiment, and a broken curve represents characteristics when no switch transistor 7 is arranged to have no voltage drop ΔVdown of the floating diffusion FD. According to this embodiment, a change width of the VSIG voltage is increased, thus expanding an output dynamic range.

That is, in this embodiment, the ON/OFF state of the amplification transistor in each unit pixel is controlled by changing the voltage PXVDD of the intra-pixel power supply line between two values, and a voltage rise of the floating diffusion FD in each unit pixel of each unselected row can be suppressed using capacitive coupling between the floating diffusion in each unit pixel of each unselected row and the vertical signal line. As a result, the output dynamic range can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array in which a plurality of unit pixels are arranged in a matrix, and each pixel unit comprises a photodiode which photoelectrically converts incoming light and accumulates a signal charge, a read transistor which reads out the signal charge accumulated by the photodiode to a floating diffusion, a reset transistor which is connected between an intra-pixel power supply line to which one of a first voltage and a second voltage higher than the first voltage is supplied, and the floating diffusion, and sets the floating diffusion at one of the first voltage and the second voltage, and an amplification transistor which is connected between the intra-pixel power supply line and a vertical signal line, and amplifies a voltage of the floating diffusion;
a load transistor and a first switch transistor which are connected in series between the vertical signal line and a reference potential supply node; and
a second switch transistor which outputs a bias voltage to the vertical signal line,
wherein during a period in which the first voltage is supplied to the intra-pixel power supply line, the floating diffusion in each unit pixel of an unselected row of the plurality of unit pixels is set at the first voltage via the reset transistor, and during a period in which the second voltage is supplied to the intra-pixel power supply line, the floating diffusion in each unit pixel of a selected row of the plurality of unit pixels is set at the second voltage via the reset transistor, so as to attain row selection of the pixel array.

2. The device according to claim 1, wherein the bias voltage is higher than a voltage which is output from each unit pixel of the selected row to the vertical signal line.

3. The device according to claim 1, wherein the first switch transistor is an N-channel MOSFET, and the second switch transistor is a P-channel MOSFET.

4. The device according to claim 1, wherein each unit pixel further comprises a signal line, which is arranged parallel to the vertical signal line, and connects the floating diffusion and a gate electrode of the amplification transistor.

5. The device according to claim 4, wherein the signal line is arranged further parallel to the intra-pixel power supply line.

6. The device according to claim 1, wherein the second switch transistor outputs the bias voltage to the vertical signal line when the first voltage is supplied to the floating diffusion of each unit pixel of the unselected row.

7. The device according to claim 6, wherein the first switch transistor is enabled after the bias voltage is output to the vertical signal line, so as to control a voltage of the vertical signal line to drop.

8. The device according to claim 7, wherein the vertical signal line controls a voltage of the floating diffusion to drop via capacitive coupling between the vertical signal line and the floating diffusion of each unit pixel of the unselected row upon occurrence of a voltage drop caused when the first switch transistor is enabled.

9. A solid-state imaging device comprising:
a pixel array in which a plurality of unit pixels are arranged in a matrix, and each pixel unit comprises a photodiode which photoelectrically converts incoming light and accumulates a signal charge, a read transistor which reads out the signal charge accumulated by the photodiode to a floating diffusion, an intra-pixel power supply line to which a first voltage is supplied during a first period, and a second voltage higher than the first voltage is supplied during a second period after the first period, a reset transistor which is connected between the intra-pixel power supply line and the floating diffusion, and an amplification transistor which is connected between the intra-pixel power supply line and a vertical signal line, and amplifies a voltage of the floating diffusion;
a row selection driving circuit configured to selectively drive the plurality of unit pixels for respective rows, and configured to enable the reset transistors of a plurality of unit pixels of an unselected row by supplying a first pulse signal during the first period, and configured to enable the reset transistors of a plurality of unit pixels of a selected row by supplying a second pulse signal during the second period, and configured to enable the read transistors of the plurality of unit pixels of the selected row by supplying a third pulse signal during the second period;
a load transistor which is connected between the vertical signal line and a reference potential supply node;
a first switch transistor which is connected in series with the load transistor, and is enabled during the second period and before the reset transistors of the plurality of unit pixels of the selected row are enabled; and
a second switch transistor which is connected between the vertical signal line and a supply node of a bias voltage, and is enabled to output the bias voltage to the vertical signal line during the first period and during a period in which the reset transistors of the plurality of unit pixels of the unselected row are enabled.

10. The device according to claim 9, wherein the bias voltage is higher than the second voltage.

11. The device according to claim 9, wherein the first switch transistor is an N-channel MOSFET, and the second switch transistor is a P-channel MOSFET.

12. The device according to claim 9, wherein each unit pixel further comprises a signal line, which is arranged parallel to the vertical signal line, and connects the floating diffusion and a gate electrode of the amplification transistor.

13. The device according to claim 12, wherein the signal line is arranged further parallel to the intra-pixel power supply line.

14. The device according to claim 9, wherein the vertical signal line controls a voltage of the floating diffusion to drop after the second switch transistor outputs the bias voltage and when the first switch transistor is enabled to change a voltage toward a ground potential.
